(19) United States
(12) Patent Application Publication
(10) Pub. No.: US 2011/0132939 A1
(43) Pub. Date: Jun. 9, 2011

(54) Method and Apparatus for Enabling Smoother, Faster Discharge of Fluid from Containers

(76) Inventor: Dennis L. Brooks, Aurora, CO (US)

(21) Appl. No.: 13/026,139

(22) Filed: Feb. 11, 2011

Related U.S. Application Data
(63) Continuation-in-part of application No. 12/538,713, filed on Aug. 10, 2009.

(51) Int. Cl. B67D 3/00; B65D 51/16

(52) U.S. Cl. 222/481

(57) ABSTRACT

The device disclosed herein relates to an automatic demand valve that allows for the rapid discharge of liquid from a bottle or container and which overcomes a glugging action and/or container collapse. The valve opens when demand is placed thereon and closes when demand ceases.

### CROSS-REFERENCE TO RELATED APPLICATIONS

This application is a continuation-in-part of application Ser. No. 12/538,713 filed Aug. 10, 2009.

### FIELD OF ART

The disclosed device and method relate generally to a valve that allows for the rapid discharge of fluid from a bottle or container, and more specifically to an automatic demand valve which opens when demand is placed on the valve and which overcomes a glugging action encountered and/or container collapse.

### BACKGROUND

It is common knowledge that a container that has a reduced area for an outlet will “glug” (the outgoing liquid will alternate with the incoming air) when it is tilted to remove the liquid contained therein. This is a nuisance and can be a hazard if toxic or flammable materials are involved. One solution has been to punch a hole in the bottom of the container away from the opening. This smoothes the flow nicely but there is a drawback. The container must be emptied all at once or the contents will exit through the hole. When a fluid is toxic or flammable, this can create a hazardous situation. In the case of larger bottles or containers, fluid head pressure may also be sufficient to cause resilient collapsing of the container as the fluid is discharged.

Thus, there is a need for a smoother discharge of fluids from a container or vessel. Although the disclosed device has relation to containers that are common in daily residential and household uses, it is contemplated that the disclosed device could be applicable to industrial, commercial, and agricultural uses.

There are a number of containers that incorporate a cap or lid with a second conduit to vent air into the container. In addition, there are a number of quick drain systems for engines, gas tanks, reservoirs, oil filters, etc. utilizing assisted and, more relevantly, non-assisted gravity drainage. Further, it is commonly known that providing a puncture in a container remote from the desired container opening creates an air entry passage, cf., can of beer, can of chicken broth, etc.

In addition, the Applicant is aware that a type of demand valve used in a diving regulator controls the supply of gas by opening to provide flow when a user inhales and shuts off when inhalation stops. In these devices, typically a diaphragm in the regulator operates when the diver lowers the pressure inside the chamber by trying to inhale, releasing low pressure gas (breathing gas at ambient pressure into the chamber allowing the diver to inhale. When inhalation stops, the diaphragm moves back, closing the valve. When the diver exhales, the exhalation causes another valve to open to allow the gas to escape to the water outside. Demand valves may also be present in other face mask apparatus such as resuscitators and simple respirators in hazardous materials operations (e.g., full face respirator).

It is believed however that none of the prior art systems referred above comprise an automatic demand valve that allows for the rapid discharge of fluid from a container or vessel, the valve comprising a small-diametered hollow vent with a flexible and/or compressible member to allow air to directly enter the container.

### SUMMARY OF THE DISCLOSURE

The disclosed device pertains to an automatic demand valve that allows for the smooth discharge of fluid from a bottle or container and which overcomes a glugging action and/or container collapse. The automatic demand valve provides an entry into the void space above the liquid (container head space). Specifically, the disclosed device comprises a small-diametered hollow vent tube with a connected flexible valve to allow air to directly enter the container head space. It is contemplated that the disclosed device be mounted on any surface having communication with said head space.

An object of the disclosed device provides a valve serving as a small diameter vent tube forming an air passageway between the pouring opening and a head space.

Another object of the disclosed device is the provision of a removable valve that may be reused.

Another object of the disclosed device is the provision of a vent tube or valve which is of small diameter and is integrally mounted in the outside of a wall of a vessel.

Another object of the disclosed device is the provision of a vent tube or valve which is integrally mounted in a vessel wall so as to direct air into the vessel.

Another object of the disclosed device is the provision of an adjustable valve having a compressible spring.

Another object of the disclosed device is the provision of a power siphon apparatus.

Another object of the disclosed device is to provide a method of siphoning liquid from a container on an as-needed basis.

Another object of the disclosed device is to provide a valve assembly having a spout and mountable to a discharge end of a container.

Yet another object of the disclosed device is to provide a valve assembly mountable to a discharge end of a container having a neck.

Another object of the disclosed device is to provide a storable valve and/or valve assembly.

Yet another object of the disclosed device is to provide a receiver for a removable valve, the receiver being formed as an integral part of a container.

Another object of the disclosed device is to provide for openable valve on a container comprising a conventional pull tab.

These and other advantages of the disclosed device will appear from the following description and/or appended claims, reference being made to the accompanying drawings that form a part of this specification wherein like reference characters designate corresponding parts in the several views.

### BRIEF DESCRIPTION OF THE DRAWINGS

FIG. 1 is a cutaway illustration of one of the disclosed devices at rest in a normally closed position and installed in a vessel wall.

FIG. 2 depicts a perspective view of the device shown in FIG. 1.

FIG. 3 depicts an exploded view of the device shown in FIGS. 1, 2.

FIG. 4 is a cutaway illustration of an embodiment that has been integrated into a vessel wall.

FIG. 5 illustrates an embodiment having a compressible spring which is adjustable.

FIG. 6 illustrates an alternate embodiment of the device shown in FIG. 5.

FIG. 7A is a cutaway illustration of an alternate embodiment of the disclosed device at rest in a normally closed position and installable in a vessel wall.

FIG. 7B is an end view of the device shown in FIG. 7A.

FIG. 7C is a perspective view of the device shown in FIGS. 7A, 7B in an activated or open position.

FIG. 7D depicts the embodiment of FIGS. 7A-7C mounted in a wall of a container.

FIG. 8A illustrate alternate embodiments of the disclosed device as mounted in a container having a neck.

FIG. 8B depicts a cross section of an end of the container shown in FIG. 8A, the disclosed device viewed from an interior of said container end.

FIG. 8C depicts a cross section of the container end in FIG. 8A as viewed from an external side position.

FIG. 9A illustrates another embodiment of the disclosed device.

FIG. 9B shows the embodiment of FIG. 9A as mounted in an end of a container.

FIG. 9C depicts an alternate embodiment of the embodiment shown in FIG. 9A.

FIGS. 10A, 10B illustrate an alternate embodiment of the disclosed device in arrangement with a container, whereby the combination forms a siphonable apparatus referred to herein as a “power siphon”.

FIGS. 11A, 11B depict another embodiment of the disclosed device.

FIG. 12 depicts the disclosed device adaptable for use in an industrial application.

Before explaining the disclosed embodiments of the disclosed device in detail, it is to be understood that the device is not limited in its application to the details of the particular arrangements shown, since the device is capable of other embodiments. Also, the terminology used herein is for the purpose of description and not of limitation.

### DESCRIPTION OF THE DISCLOSED EMBODIMENTS

The following description is provided to enable any person skilled in the art to make and use the disclosed apparatus. Various modifications, however, will remain readily apparent to those skilled in the art, since the generic principles of the present apparatus have been defined herein to provide for an automatic demand valve that allows for the smooth discharge of liquid from a container or a vessel.

The basic function of a check valve is to allow forward flow under normal conditions and prevent flow reversal. Presently, there exist many types of check valves or non-return valves designed to control the one-way flow of a fluid therethrough. The bodies or external shells of most check valves are made of plastic or metal. Check valves are two-port valves, meaning each has two openings in the valve body, one for fluid to enter and the other for fluid to exit. In short, fluid flows through the valve in only one direction. In this regard, the disclosed device resembles a check valve. However, the disclosed device differs from a typical check valve, i.e., diaphragm valve, ball check valve, etc. in several ways.

A diaphragm valve uses a flexing rubber diaphragm positioned to create a normally-closed valve. Pressure on the upstream (or inlet) side must be greater than the pressure on the downstream (or outlet) side by a certain amount, known as the pressure differential, for the diaphragm valve to open allowing flow. Once positive pressure stops, the diaphragm automatically flexes back to its original closed position.

In the example of a ball check valve, a ball serves to block the fluid flow. In some cases, the ball is spring loaded to help keep the valve shut. As pressure is exerted on the ball, the spring is compressed and the valve is opened. Once positive pressure stops, the ball is reseated in its original closed position. For designs that do not utilize a spring, reverse flow would be required to move the ball toward the seat and create a seal.

As stated above, the basic function of a check valve is to allow forward flow under normal conditions and avoid flow reversal. The disclosed device, however, functions as an “equalizer valve.” When pressure on the inlet end of the valve is greater than the pressure on the outlet end of the valve, a differential in pressure exists causing flow to the low pressure region. For example, if pressure at a point A (inlet side) is 5 psi and pressure at a point B (outlet side) is 4 psi, flow is from A to B until the pressure at point B approaches 5 psi. The slight difference in pressures at points A and B is the closing tension of the flexible portion of the valve. Under most conditions, pressure at point B will be equal or less than the pressure at point A. When carbonated beverages or other gas-generating liquids are on the B side of the valve (outlet), the B side can be at a higher pressure than the A side. This is also the case when the chamber the valve is located in is at a higher altitude and the A side is at a lower pressure.

Air enters the bottle through the valve instead of the mouth or neck portion to fill the space previously occupied by liquid to equalize the negative pressure induced by the passage of liquid from the bottle. The valve opens to allow air passage when lower pressure is produced within the container (when the container is canted) and closes when demand for air is alleviated. It is to be understood that the valves disclosed herein may be removed after use if desired and saved for later reuse. Alternately, the devices may take the form of a permanently mounted valve when justified by the application.

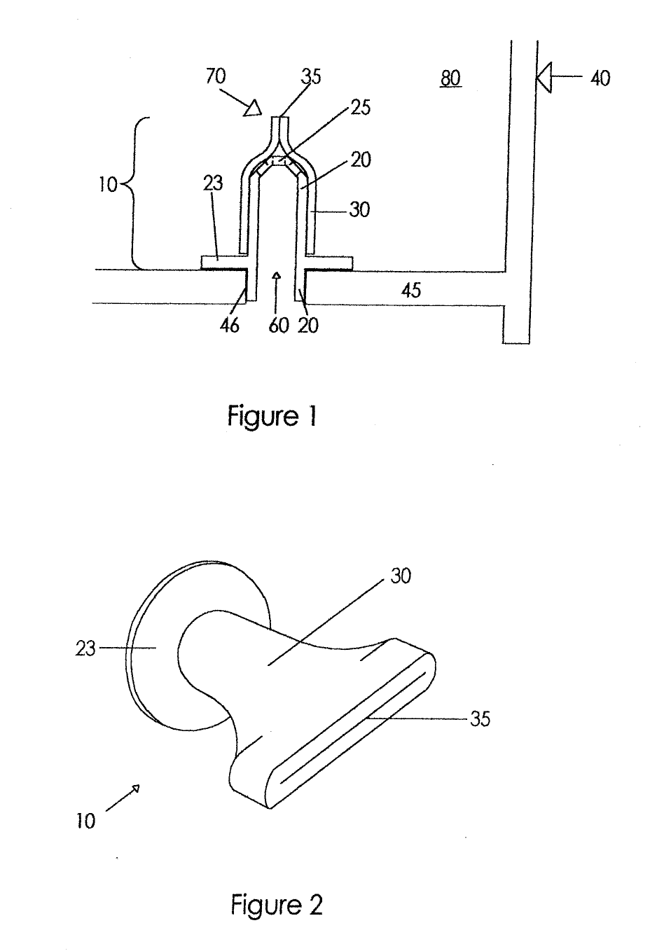

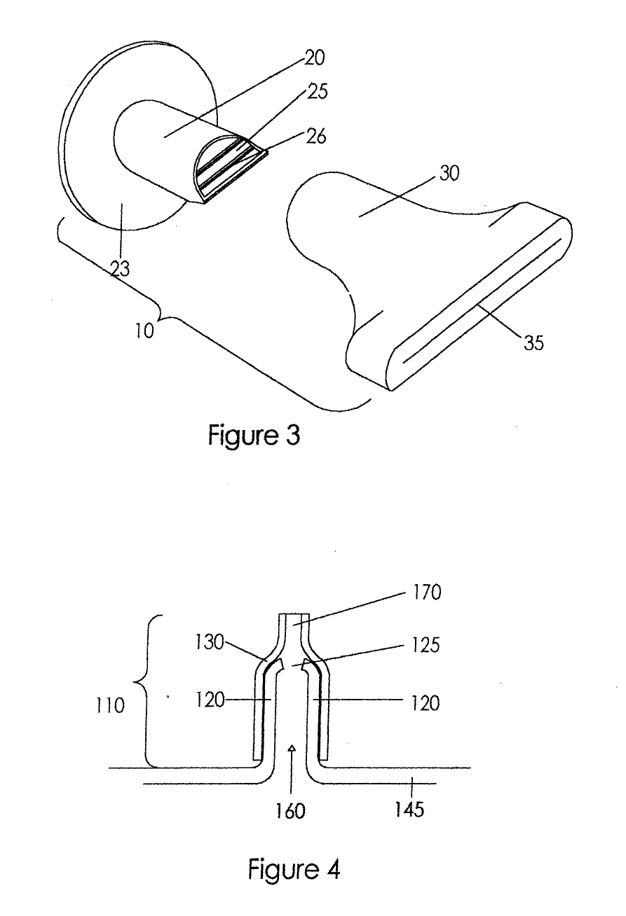

In the cutaway view of FIG. 1, valve 10 is shown positioned in an orifice 46 in a bottom wall 45 of a container or vessel 40. Valve 10 comprises a substantially rigid member 20 sheathed by a flexible member 30. Rigid member 20 comprises a flange 23 at one end and one or more apertures 25 at an opposite end. See also FIGS. 2, 3. In this example, apertures 25 are defined by one or more slim bars 26. Flexible member 30 comprises an aperture 35 that may be opened or closed as conditions dictate, i.e., “on demand.” In this embodiment, aperture 35 takes the form of a slot. Aperture 35 of flexible member 30 forms the outlet port 70 shown in FIG. 1.

In use, valve 10 may be positioned in wall 45 of vessel 40 in such a way that atmospheric air enters the vessel's head space 80 when demand is placed on the device. One having skill in the art will recognize that the valve could be installed in an end of a vessel or in an appropriate side wall depending on the orientation of the vessel and the fluid housed therein. As long as a pressure differential can be created, the valve may be positioned adjacent the vessel's head space or beneath the fluid level if suitable.

The disclosed device can be mounted in a hole or orifice 46 which pierces through a vessel wall. The inner diameter of the hole may be the approximate diameter of the outer diameter of the valve. To help ensure a close fit, the diameter of the hole could be designed to be smaller than the outer diameter of the valve if suitable. For example, a ¼″ diameter hole could be plugged with a valve having a rigid member with a diameter of slightly greater than ¼″. One having skill in the art would recognize that an orifice could be formed in an appropriate vessel by conventional methods and then retrofitted with a valve as disclosed herein. Seat members 21 may be mounted in orifice 46 such that flange 23 can closely abut an adjacent inner surface of the vessel. Thereafter, flexible member 30 could be mounted over rigid member 20.

Generally, a normally closed valve is defined as one in which the valving element is closed when de-energized (unactuated), preventing flow. When such a valve is actuated, the valving element is opened to allow flow. A normally open valve is thus defined as one in which the valving element is open when unactuated, allowing flow. When such a valve is actuated, the valving element closes to prevent flow.

It is contemplated that the valve 10 embodiment is a normally closed valve. Outlet port 70 is shown to be closed and flexible member 30 is at rest. By tipping the vessel 40 and thereby creating a pressure differential, aperture 35 of flexible member 30 opens. An opened aperture 35 would somewhat resemble an opening not unlike that which appears when pressing on the sides of a slotted coin purse. Air is drawn into valve 10 via inlet port 60 and out of valve 10 via apertures 25, 35 and outlet port 70. As air is drawn into head space 80 (or vessel 40 generally), a fluid (not shown) that is contained in vessel 40 can be discharged from the vessel via its top opening (not shown) in an expeditious manner with essentially no glugging.

To create the pressure differential, the vessel can simply be canted at a normal pouring angle that need not be overly inverted. As the fluid leaves the container, the internal pressure decreases causing the disclosed device to open, allowing air inflow and thus acting as a “demand valve.” To stop the discharge of liquid, the outlet of the vessel is rotated above the liquid surface. Because the demand on the valve is alleviated, aperture 35 of flexible member 30 returns to its normally closed position, thereby preventing the flow of fluid through apertures 25.

As stated above, the disclosed device has relation to containers that are common in daily residential and household uses. Therefore, one having ordinary skill in the art would recognize that the materials of construction should meet requirements set by the U.S. Food & Drug Administration (FDA) for food-grade packaging if the use of the disclosed device contemplates the ingestion of a vessel's contents. It is also contemplated that the disclosed device could be used for vessels in industrial, commercial, and agricultural settings or anywhere where there is a need for smoother discharge of liquids. Non-food grade embodiments could be constructed from materials such as thermosetting plastics, e.g. phenolic resins, which remain permanently hard after being formed and cooled. Thermoplastics which remain flexible, .e.g. high-density polyethylene (HDPE) and vinyl resins can also be used along with various elastomers. One having ordinary skill in the art would recognize that the materials of construction should meet regulatory and engineering requirements. In addition, the dimensions of the valves, valve components, housings, apertures are sizeable as needed.

In some cases, it may be desirable to manufacture a container or vessel having the disclosed valve mounted in place. FIG. 4 depicts an alternate embodiment 110 which comprises a flexible member 130 and an integrated member 120 which is formed into wall 145 of a vessel (not shown). Integrated member 120 could somewhat resemble a punt of a wine bottle if the punt were to have steep sides and an orifice. One having skill in the art would recognize that there are numerous ways of integrating such a member in a vessel wall and the particular shape and size of the member to be implemented.

Integrated member 120 is sheathed by a flexible member 130 and comprises a channel 125 that allows flow therethrough. Flexible member 130 comprises an aperture (see aperture 35 of FIG. 3) through which flow may pass. The aperture (not shown) of flexible member 130 forms the outlet port 170. Rotating the vessel past or below a horizontal axis causes air to be drawn into valve 110 via inlet port 160 and out of valve 110 via channel 125 and outlet port 170, shown open.

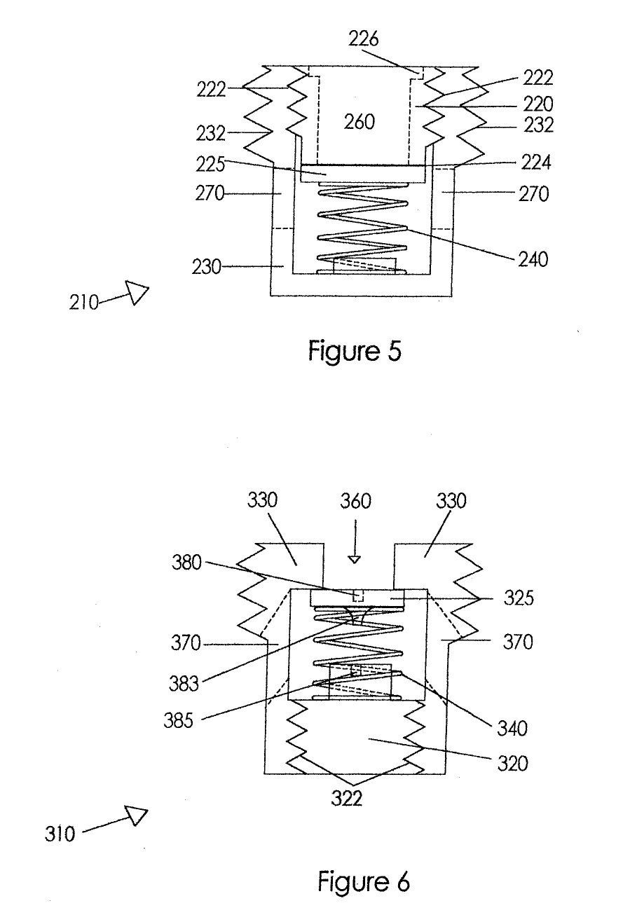

FIG. 5 depicts an alternate embodiment of the disclosed device wherein the valve comprises an assembly having a plate 225 and a compressible spring 240. It is contemplated that valve embodiment 210 could be employed in situations involving higher pressures like in the case of carbonated fluids. Valve 210 is removable from the vessel wall if desired and can be saved for later reuse.

Valve 210 comprises a core 220 and a housing 230 having external threads 232 to enable the mounting of the device into (and its removal from) an appropriate orifice in a vessel wall (not shown). Housing 230 further comprises longitudinal wall slots 270 which serve as outlet ports. The open tube of core 220 forms the inlet port 260.

Core 220 is adapted to be received by housing 230 and may be secured thereto by means of threads 222. In other words, core 220 is insertable in an open end of housing 230 whereby the core and the housing can be adjusted in relation one with the other. Core 220 can travel inwardly or outwardly which thereby causes plate 225 to respectively travel inwardly or outwardly. Spring 240 is shown mounted in housing 230 and secured therein by plate 225 and an end 224 of core 220. As shown, plate 225 serves to cover or close the inlet port 260. Valve 210 is a normally closed valve. The tension on spring 240 is adjusted by rotating core 220 in threads 222 with a tool (not shown) that engages slot 226 in core 220. Low spring tension results in a very sensitive valve.

While this valve can be used in the same manner as the valve of FIG. 1, the primary applications envisioned are in containers which are too heavy to be easily rotated beyond the horizontal such as, but not limited to, beer kegs, fuel and oil barrels, and other larger containers. Such containers already contain an exit, i.e., valve or other exit control, and periodic content removal is the common practice. The devices disclosed herein allow for the smooth discharge of liquid from such container and in the case of a beer keg, can eliminate the need for the use of a keg pump. Valve 210 and valve 310 open whenever liquid is withdrawn from the container and close when the removal of liquid stops.

As referenced above, an operator could utilize a tool in the open tube of core 220 to adjust the tension of spring 240. Alternately, valve 210 could comprise an external mechanism such as lever or knob mounted external to base 220 to facilitate the adjustment of the plate 225 and spring 240.

In the embodiments disclosed here, the springs and plates are composed of brass for that material's strength, resistance to corrosion, appealing appearance, and ability to be easily formed. In addition, the bases, assemblies, and housings are cylindrical. Any suitable material of construction and configuration could be used depending on the particular application and still fall within the scope of the disclosure.

It is recognized that base 220 could protrude past an exterior edge of a vessel to cause undesired vessel rocking. This could also occur as a result of the location of the external lever/knob mechanism described above. Therefore, it may be advantageous to incorporate this embodiment in vessels having an indentation or concave end to reduce vessel instability when it is placed on substantially planar surface such as a table. For example, the device could be utilized in a glass or plastic bottle having a punt or a kick-up. One having ordinary skill in the art would know the degree of the rise and configuration of the bottle base to be utilized to accommodate the addition of the disclosed valve.

FIG. 6 illustrates an alternate embodiment of the disclosed device discussed in FIG. 5. Valve 310 is a normally closed valve that comprises an assembly 320 and a housing 330 having external threads to enable the mounting of the device into (and its removal from) an appropriate orifice in a vessel wall (not shown).

Assembly 320 is mounted in housing 330 and can be secured thereto by means of internal threads 322. Assembly 320 can travel inwardly or outwardly along internal threads 322. Housing 330 further comprises wall slots 370 which serve as outlet ports.

Spring 340 and plate 325 are mounted in assembly 320. Plate 325 is seated against inlet port 360 to prevent flow therethrough. The diameter of port 360 should be sufficiently small so as to retain plate 325 within housing 330.

Plate 325 comprises a male member 383 that is mateable with female member 385. Plate 325 further comprises screw head 380 that can be useful for adjusting valve 310. In use, an operator could insert the tip of a screwdriver into screw head 380 to turn assembly 320. Placing pressure on plate 325 will cause spring 340 to compress so that female member 385 can receive male member 383. Depending on the direction of the turn, assembly 320 may travel inwardly or outwardly. When assembly 320 advances inwardly, tension on spring 340 is increased. A larger pressure differential is thus required before plate 325 is displaced to answer the demand.

One having skill in the art would recognize that in some cases it may be desirable to place the valve's adjustment means on the outlet side of the valve. This type of placement could be useful to prevent tampering with by other than designated individuals. In addition, it is contemplated that some embodiments could be two-way adjustable. In other words, a valve can be adjusted on its inlet side and/or the outlet side.

Though not shown, the disclosed device could comprise closure means that can be used to lock the valve in place in a vessel. This feature of the device could be useful to prevent tampering with or removal of the valve. For example, a safety wire could be threaded through the vessel walls adjacent the inlet ports disclosed herein. When the device is ready to be engaged, the closure means can be removed by snipping the wire to allow access to the valve. One having skill in the art, however, would recognize that any suitable closure means could be employed to facilitate safety and secure transport of valve installed in a liquid-containing vessel and to disallow removal or theft of the valve. In addition, the safety wire could be crimped or otherwise reinforced.

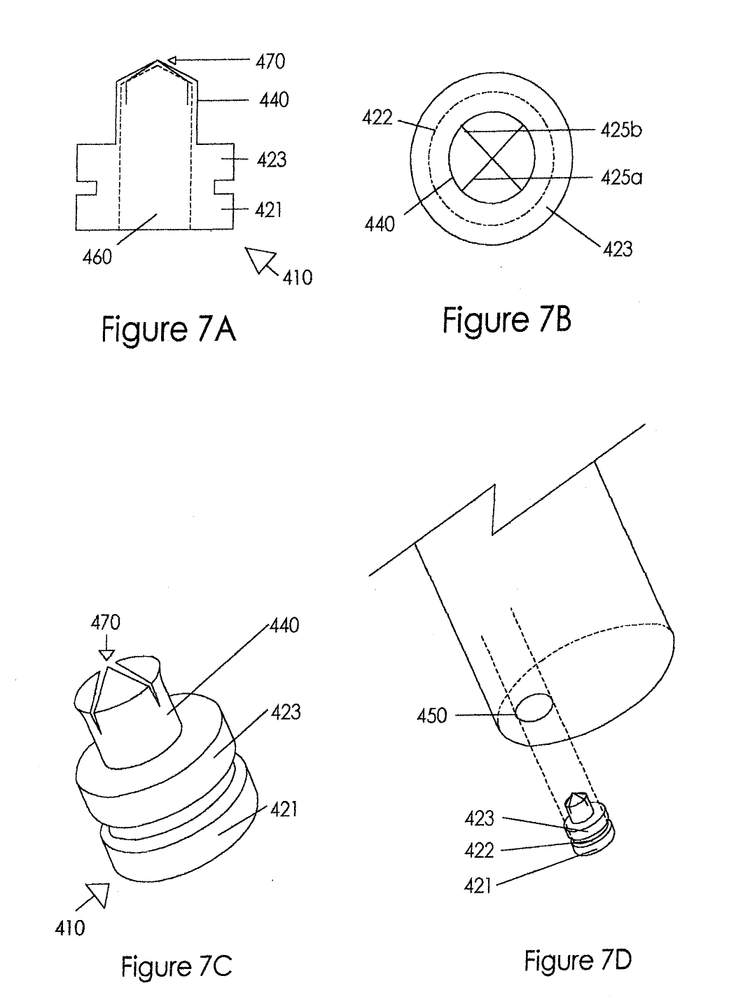

FIGS. 7A and 7B depict an alternate embodiment of the disclosed device at rest in a normally closed position. FIG. 7C depicts the device in an open position. Valve 410 is substantially flexible and may be installed in an orifice in a wall of a container or vessel. Valve 410 comprises a pair of flanges 421, 423 adjacent an inlet port 460. End member 440 comprises an outlet port 470. As shown in FIG. 7D, the disclosed device can be mounted such that a wall edge 450 of a container that is adjacent an orifice is seated in groove 422 between the pair of flanges 421, 423. End member 440 comprises perpendicular slots 425a, 425b capable of forming an aperture that may be opened or closed (see also FIG. 7B).

One having skill in the art would recognize, however, that the valve could be installed in t an appropriate side wall at the lower end of the container. In addition, one having skill in the art would recognize that a covering means could be employed to facilitate safety and secure transport of a valve installed in a liquid-containing vessel. For example, a security seal could be placed over the inlet side of the valve to protect the valve and/or to disallow removal, tampering, or theft of the valve.

In another contemplation of the disclosed device, the portion of the valve which comprises flanges 421, 423 could be located distally from end member 440. The two portions could then be connected together by means of a substantially rigid tube member. This variation of the disclosed device could be installed in a vessel such as a soda can (not shown). Assuming an orifice was to be placed in the top wall of a soda can, e.g., directly behind the can's pop-top, flange 421 would rest above the top of the can while flange 423 is positioned below the surface of the can. Although not shown, the tube member and end member 440 would extend into the can.

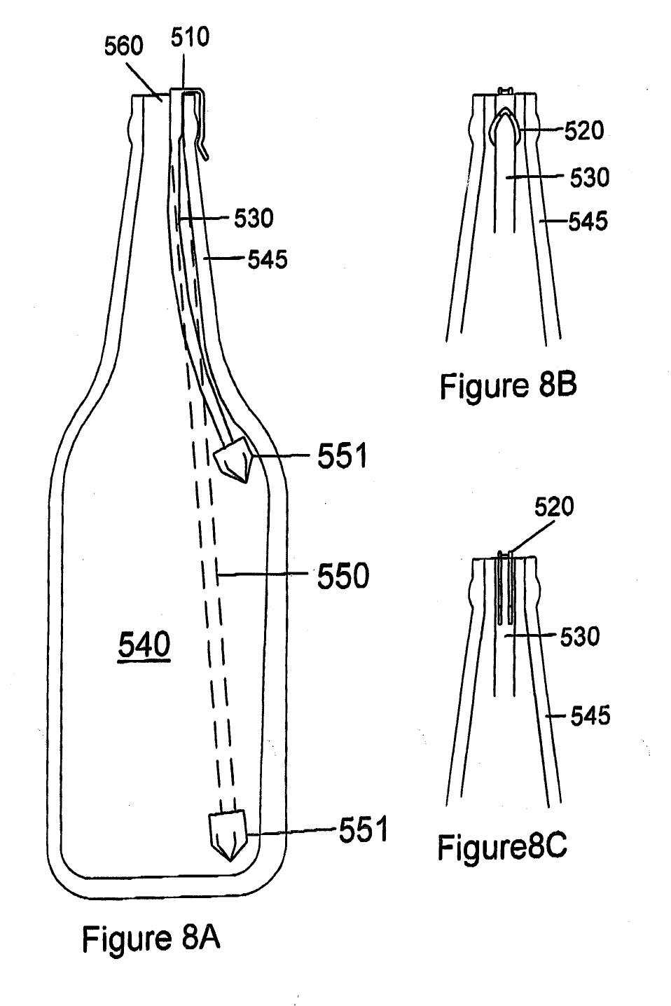

FIG. 8A depicts another embodiment of the disclosed device. Vent tube 530 provides a conduit between the atmosphere that is exterior to the necked container and the void that forms at the shoulder of the container when the container is tilted to pour out the contents. Air travels through the conduit from the higher pressure area exterior to the container to the lower pressure area within the container (the void) while the fluid flows smoothly through the end 560. Vent tube 530 essentially acts as a demand valve in conducting the air from higher pressure to lower pressure. Vent tube 530 can be maintained in position by a clip attachment 510 which can be co-molded with the vent tube 530 to provide a unified configuration. Depending on the specific conditions within the container and the fluid it houses, it is contemplated that a demand valve 549 could be placed at the terminus of tube 530 so as to keep fluid from entering the tube.

Also depicted in FIG. 8A is an alternate arrangement wherein the tube 550 may be extended the length of the chamber. The purpose of the demand valve 551 at the terminus of the tube 550 is to exclude the fluid from the length of the tube 550. In addition, the demand valve 551 enables the system to be more consistent in operation.

A small shortening of the interval between the tilting of the container and free flow may be obtained by mounting a demand valve 551 to the vent tube 530 but the interval should be small enough to be inconsequential. As the tube is lengthened toward the length of tube 550, this interval lengthens with the tube length, and becomes significant at about half the length of tube 550 in this application. Therefore, demand valve 551 can be used to exclude the fluid from the tube 550 to keep the performance consistent with tube 530.

FIGS. 8B, 8C are respectively interior and exterior views of a container end having a bent wire retainer 520 mounted thereto. The retainer 520 may be used as a substitute for the co-molded retainer depicted in FIG. 8A

Tube member 530 can be rigid or flexible. For example, a conventional plastic straw could be used. In one contemplation, a food-safe adhesive could be used to fasten an end of a bendable plastic straw to the inside lip of a glass bottle.

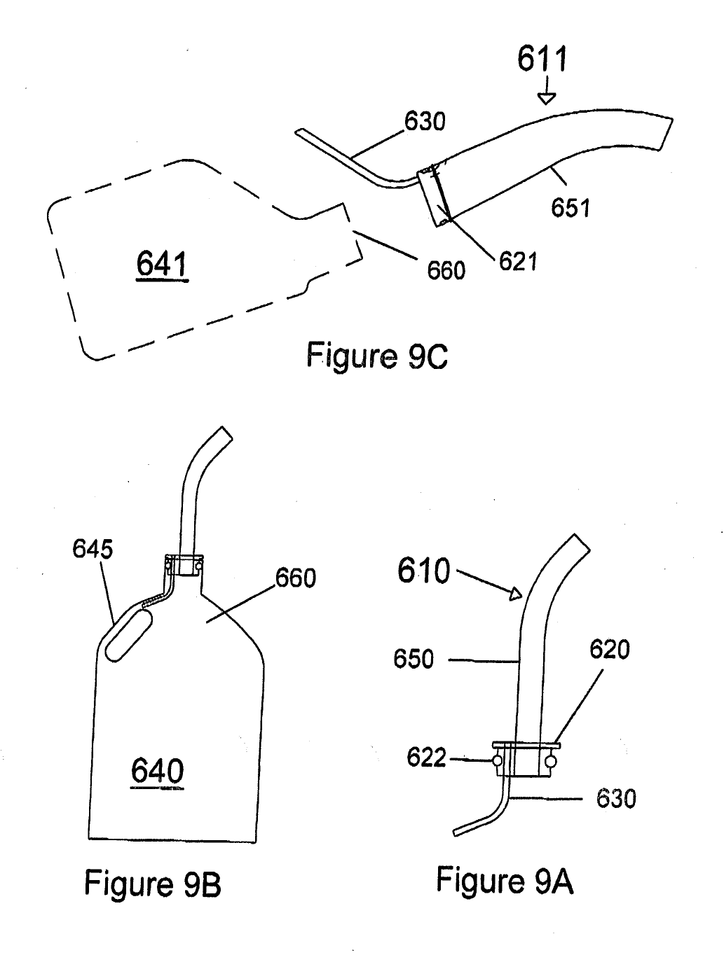

FIGS. 9A to 9C depict alternate embodiments of the disclosed device. As shown in FIG. 9A, valve 610 comprises a spout 650, a mounting assembly 620 and a tube member 630. Mounting assembly 620 can be installed at an open end 660 of container 640. A mechanical gasket 622 can be used to create a seal at the interface. Tube member 630 is attachable to mounting assembly 620. In FIG. 9B, valve 610 is shown mounted in end 660 of container 640 having a handle 645. In operation, tube member 630 is positioned adjacent handle 645.

It is contemplated that in some cases, valve 610 could be inverted such that spout 650 may reside in container 640 for storage purposes. Mounting assembly would be designed accordingly so as to be reversibly installed in open end 660. Tube member 630 could be removably attachable and stored in a receiving groove, for example, on a suitable location on handle 645 or on the outer surface of container 640.

A simplified version of the disclosed device is depicted in FIG. 9C. Here, valve 611 comprises a spout 651 and a mounting assembly 621 installable at an open end 660 of container 641. In operation, tube member 630 is positioned adjacent the inner curved wall of container 641.

One having skill in the art would also recognize that one or more of the embodiments disclosed herein could take the form of a retrofit valve installable in a container such as a soda can, a soup can, glass or plastic bottle, etc. whereupon the valve could be removed after use and saved for later reuse. Alternately, the embodiments could take the form of a permanently mounted valve if so justified by the application. For example, a permanent-mount valve could be useful in the case of vessels containing hazardous materials. One having skill in the art would recognize that a sealing means could also be employed to facilitate safety and secure transport of a valve installed in a liquid-containing vessel. A security foil or seal could be placed over a container orifice designated to accept the insertion of the valve.

It should be evident that one or more of the disclosed embodiments may have relation to containers that are common in daily residential and household uses. The materials of construction, e.g., plastic, metal, etc. should meet requirements set by the FDA for food-grade packaging, as necessary. It is also contemplated that the disclosed device could be used for vessels in industrial, commercial, and agricultural settings or anywhere where there is a need for more effective discharge of liquids. One having ordinary skill in the art would recognize that the materials of construction would thus be chosen accordingly.

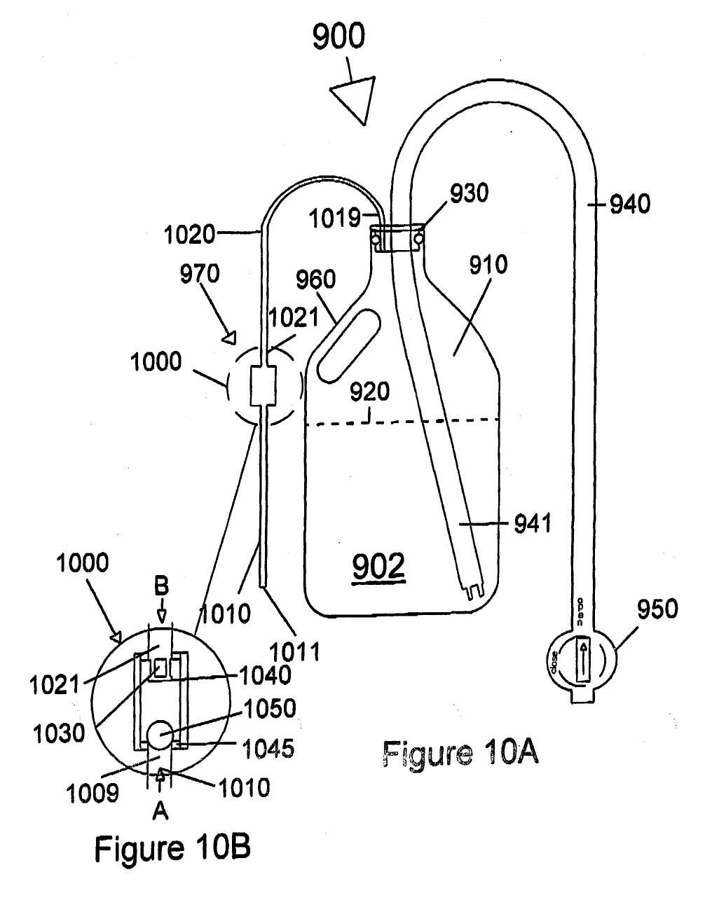

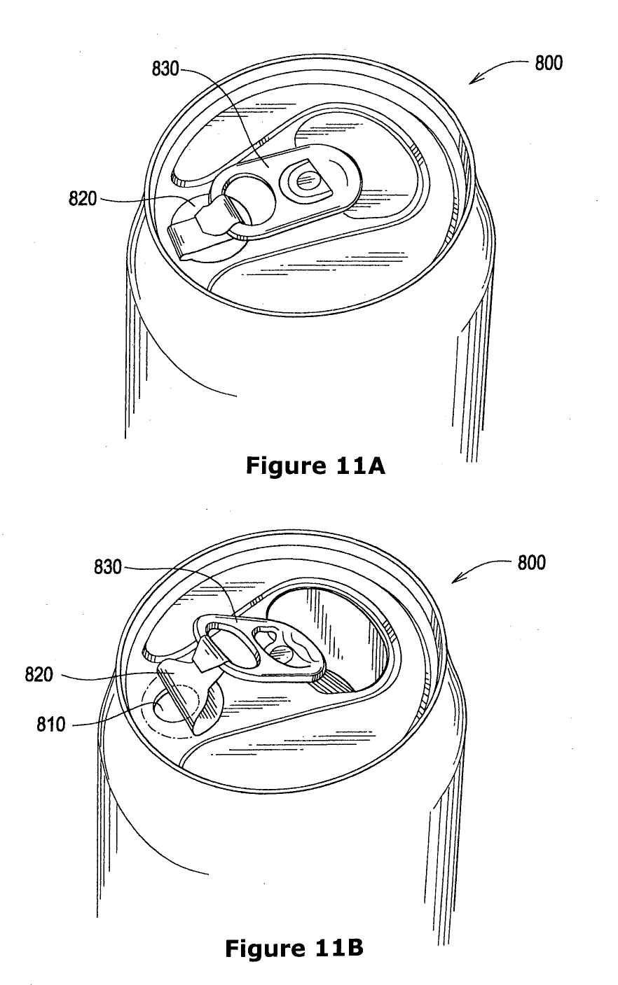

FIG. 10A illustrates an alternate embodiment of the disclosed device in arrangement with a container, whereby the combination forms a siphon-type apparatus. Embodiment 900, which can be referred to as a “power siphon”, comprises valve 1000. Similar to the valves mentioned herein, valve 1000 is an automatic demand valve that allows for the rapid discharge of liquid from a container. Valve 1000 operates to open and close airspace 910. Flow is regulated by valve 950.

In this embodiment, container 902 comprises handle 960 and top assembly 930. Tube 940 is mounted in top assembly 930 and is situated such that one of its ends terminates in liquid 920; the other of its ends terminates at a position lower than the bottom of the container.

Valve assembly 970 comprises valve 1000 and tubes 1010, 1020. End 1019 of tube 1020 is mountable in top assembly 930. As seen in FIG. 10B, end 1021 of tube 1020 is attachable to an end of valve 1000; end 1009 of tube 1010 is attachable to an opposite end of valve 1000. Stop ball 1050 is transitionable between seat members 1045 and 1040. End 1011 of tube 1010 terminates to atmosphere.

Air pressure is introduced into the terminus end of tube 1010 by, for example, blowing, thereby causing airflow in direction ‘A’. Air flows into valve 1000 causing internal stop ball 1050 to disengage from seat member 1045 and move toward seat member 1040. Vent holes 1030 allow air to pass through valve 1000 and into container air space 910 increasing the internal pressure exerted on liquid 920 and thereby causing liquid 920 to enter tube 940 through end 941. Tube 940 serves as a hose which facilitates a siphon out of container 902. Siphon action will continue until the container is empty or valve 950 is closed.

Stop ball 1050 will remain seated on member 1045 when end 1009 is lower than outlet end 1021. Valve 1000 is said to be in an “on-demand” mode. This position prevents any internal venting to atmosphere in direction ‘B’. It should be noted that vent holes 1030 can be designed using various geometric shapes other than that shown in FIG. 10B.

The power siphon embodiment 900 depicted in FIG. 10A provides a safe environment for many liquid toxic or flammable substances. It allows for the siphoning of such substances by simply opening or closing valve 950. Demand valve 1000 opens and closes in response to changes in pressure above the fluid in area 910. The disclosed device prevents fumes from exiting the container when the valve is positioned in an on-demand mode and valve 950 is closed. It should be evident that this embodiment has relation to containers that are common in daily residential, household, industrial, agricultural or commercial uses and where there is a need for more effective discharge of liquids via a siphon. In one example, a container having a liquid such as window washer fluid was tested. With the disclosed valve assembly, the fluid was quickly and smoothly siphoned from the container into the desired receptacle. One having ordinary skill in the art would recognize that the materials of construction would be chosen accordingly.

FIGS. 11A, 11B depict an embodiment 800 comprising a conventional pull tab 830 and a sealing means 820. FIG. 10A depicts valve 810 in a closed mode; FIG. 10B depicts valve 810 in an open and activated mode. As pull tab 810 is lifted, the sealing means is also lifted to uncover valve 810. Sealing means 820 can be made of food-grade materials such as those used in juice packaging, for example. One having skill in the art would recognize that valve 810 could be locatable at any desired position in the top section of embodiment 800.

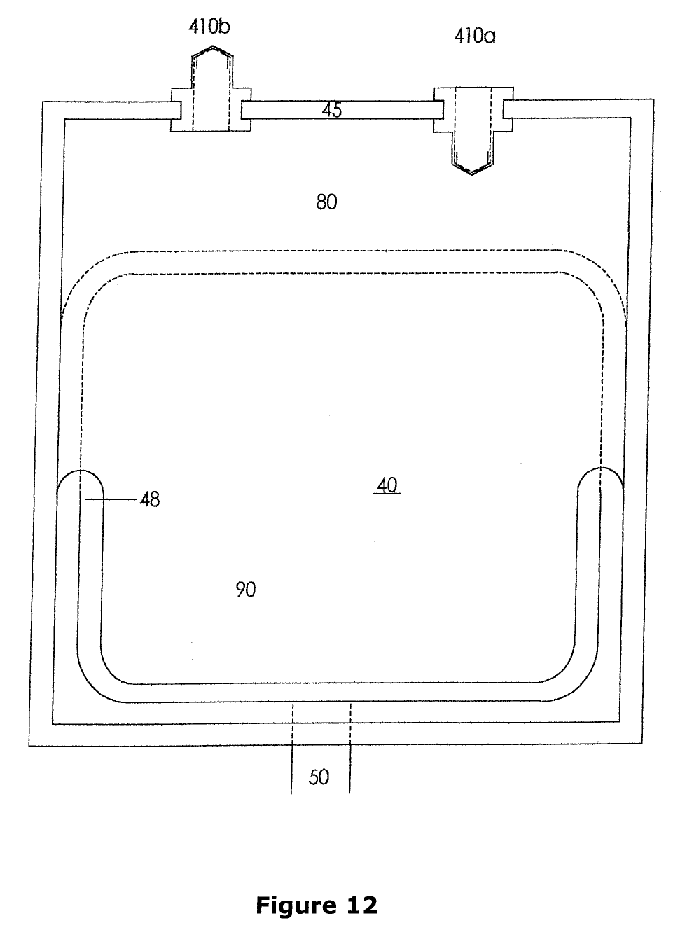

FIG. 12 depicts the disclosed device adaptable for use in an industrial application. Valves 410a, 410b are shown positioned in wall 45 of a tank vessel 40 having an industrial liner 48. As fluids are received in vessel 40, they are encapsulated in liner 48 which unfurls and expands upwardly toward the vessel's upper end. As fluids are emptied from vessel 40, liner 48 can collapse. The volume of air space 80 would thus increase or decrease depending on the volume of fluid in vessel 40 and the compression or expansion of liner 48. Valves 410a, 410b are similar to the valve set forth FIGS. 7A-7C. In this depiction, valve 410b can serve as a relief valve useful to relieve pressure in the vessel caused by the volume of fluid in vessel 40 and the nature of the liner's contents. Valves 410a, 410b operates in a push-pull fashion to maintain the area above the bladder 48 very near the external pressure independent of what occurs inside the bladder, whether it is being filled or emptied, or is expanding or contracting in response to temperature changes.

This embodiment of the disclosed device has relation to industrial tanks or vessels. Therefore, one having ordinary skill in the art would recognize that the materials of construction of the valve should meet suitable requirements set by the industry in which it will be applied.

Although the disclosed device and method have been described with reference to disclosed embodiments, numerous modifications and variations, including incorporation into the container at time of manufacture, can be made and still the result will come within the scope of the disclosure. No limitation with respect to the specific embodiments disclosed herein is intended or should be inferred.

I claim:

1. In conjunction with a container or vessel, an apparatus enabling a smooth discharge of fluid therefrom, said apparatus comprising:
a valve comprising a tube member having an upper end and a lower end, said lower end being insertable into said container or vessel;
said upper end being attachable to an inlet/outlet end of said container or vessel;
said tube member allowing air to directly enter said container or vessel when demand is placed thereon; and
said valve becoming dormant when said demand ceases.

2. The apparatus of claim 1, wherein said tube member can be extended the length of the container or vessel.

3. The apparatus of claim 1, wherein said lower end of said tube member further comprises an assembly to exclude fluid from an interior of the tube member.

4. The apparatus of claim 1, wherein said upper end of said tube member is attached to said inlet/outlet end by means of a retainer.

5. In conjunction with a container or jug, an apparatus to enable a smooth discharge of fluid therefrom, said apparatus comprising:
a valve having a mounting assembly and a spout;
said mounting assembly further comprising a tube member, an upper end of said tube member being attached thereto;
said mounting assembly installable at an inlet/outlet end of said container or jug, thereby causing a lower end of said tube member to reside in an interior of said container or jug;
said tube member allowing air to directly enter said container or jug when demand is placed thereon; and
said valve becoming dormant when said demand ceases.

6. The apparatus of claim 5, wherein said mounting assembly further comprises a mechanical gasket to create a seal between the mounting assembly and the inlet/outlet end of the container or jug.

7. The apparatus of claim 5, wherein said valve is inverted such that said spout can reside in said container or jug for storage purposes.

8. The apparatus of claim 5, wherein said tube member is removably attachable.

9. The apparatus of claim 6, wherein said tube member is storable adjacent an outer surface of said container or jug.

10. In conjunction with a container, an apparatus to enable a smooth discharge of fluid therefrom, said apparatus comprising:
a first valve assembly having a mounting assembly and a siphon tube;
said mounting assembly installable at an inlet/outlet end of said container;
said siphon tube situated such that one of its ends terminates in liquid housed in said container, the other of its ends terminating at a position lower than and external to the bottom of said container;
said external end of said siphon tube further comprising a flow regulator;
a second valve assembly having opposing tube end members;
one of said tube end members attachable to said mounting assembly, the other of said tube end members terminating to atmosphere; and
wherein an introduction of air pressure into a terminus end of said tube member causes air to pass through said second valve assembly and into an air space in said container, and whereby liquid enters said siphon tube.

11. The apparatus of claim 10, wherein said siphon tube enables a discharge of liquid from said container until said container is empty or said flow regulator is closed.

12. The apparatus of claim 10, wherein said second valve assembly further comprises a stop ball transitionable between a pair of seat members when air is introduced.

13. A valve to enable a smooth discharge of fluid from a container, the valve comprising:
a small diametered vent locatable in a top section of said container to allow air to directly enter a head space in said container when demand is placed thereon;
said vent being located adjacent an orifice through which a discharge of fluid may flow; and
said vent becoming dormant when said demand ceases.

14. The valve of claim 13 further comprising a sealing means to cover said valve while said container is in a closed mode.

15. The valve of claim 14, wherein said sealing means is openable to arrange for air passage therethrough.
